(19) United States
(12) Patent Application Publication
(10) Pub. No.: US 2022/0075841 A1
(43) Pub. Date: Mar. 10, 2022

(54) INFORMATION PROCESSING DEVICE, INFORMATION PROCESSING METHOD AND COMPUTER-READABLE RECORDING MEDIUM RECORDING INFORMATION PROCESSING PROGRAM

(71) Applicant: NEC Corporation, Tokyo (JP)

(72) Inventor: Takuya KUWAHARA, Tokyo (JP)

(73) Assignee: NEC Corporation, Tokyo (JP)

(21) Appl. No.: 17/464,906

(22) Filed: Sep. 2, 2021

(30) Foreign Application Priority Data
Sep. 9, 2020 (JP) 2020-151287

(51) Int. Cl. G06F 17/14

(52) U.S. Cl. CPC G06F 17/14

(57) ABSTRACT

The information processing device outputs an optimal solution to a binary optimization problem when the binary optimization problem including a linear inequality constraint represented by a linear inequality is input includes a constraint transformation unit which transforms the constraint to a constraint represented by the linear inequality with a coefficient size smaller than the coefficient size of the linear inequality, and an optimization unit which calculates the optimal solution of the binary optimization problem on the basis of the constraint including the linear inequality transformed by the constraint transformation unit.

This application is based upon and claims the benefit of priority from Japanese patent application No. 2020-151287, filed on Sep. 9, 2020, the disclosure of which is incorporated herein in its entirety by reference.

### TECHNICAL FIELD

The present invention relates to an information processing device, an information processing method, and a computer-readable recording medium recording an information processing program that output an optimal solution to a binary optimization problem when a binary optimization problem including a linear inequality constraint represented by at least linear inequalities is input.

### BACKGROUND ART

A combinatorial optimization technique is a general-purpose technique and is used in various fields in the real world. For example, a combinatorial optimization technique has been applied to a wide variety of industries, such as minimizing delivery costs, building efficient networks, task scheduling, and optimal allocation of human and computational resources.

In order to analyze and “deal with” big data for the real world, it is important to solve a combinatorial optimization problem with high speed and high accuracy.

One of the combinatorial optimization problems is the combinatorial optimization problem defined by constraints and objective functions on a Boolean variable (such variable taking 0 or 1 as a value). Such a combinatorial optimization problem is called a “constrained binary optimization problem” (or “0-1 optimization problem”, “pseudo-Boolean optimization problem”, etc.).

The “constrained binary optimization problem” dealt with in this application will be explained with a specific example of the problem. The following equation OPT. 1 is an example of a constrained binary optimization problem.

(OPT. 1)

### [Objective Function]

x1+2*x2+3*x3+2*x4 (1)

### [Constraints]

x1+x2+2*x3=2 (2)

x1+x3≤1 (3)

3*x1+2*x2+3*x3+x4≥4 (4)

The equation OPT.1 is a constrained binary optimization problem that consists of one objective function (1) and three constraints (2), (3), and (4), and includes four variables: x1, x2, x3, and x4.

The variables x1, x2, x3, and x4 are Boolean variables and take 0 or 1 as their value.

The constraints (2), (3), and (4) represent the constraints to be satisfied by each variable in a constrained binary optimization problem. Here, * represents multiplication, + represents addition, and =, ≤, ≥represent magnitude correlation of values. Thus, the constraint (2) requires the value of x1+x2+2*x3 to be equal to 2. The constraint (3) requires that the value of x1+x3 be less than or equal to 1. The constraint (4) requires that the value of 3*x1+2*x2+3*x3+x4 be greater than or equal to 4.

Among the constraints included in the equation OPT.1, the constraints (3) and (4) are called linear inequality constraints. In other words, a linear inequality constraint is a constraint that is expressed in the form of comparing the left side which is the sum of “(constant)*(variable)”, and the right side which is the constant term, with “≥” or “≤”.

The set consisting of all the assignments of values to variables that satisfy the constraint C is called the “satisfaction domain” of the constraint C. For example, the satisfaction domain of the constraint (2) is (x1, x2, x3, x4)={(1,1,0,0), (1,1,0,1), (0,0,1,0), (0,0,1,1)}.

Note that if the satisfaction domains are equal, the constraints will have the same meaning even if they are expressed differently. For example, the constraint (2) has exactly the same satisfaction domain as “x1+5*x2+6*x3=6 . . . (2′)”, so even if the constraint (2′) is included as a constraint instead of the constraint (2), the solution of the equation OPT.1 will not change at all. In the following, two inequality constraints with the same satisfaction domain will be expressed as “equivalent”.

The objective function (1) indicates the target to be optimized by the constrained binary optimization problem OPT.1. Thus, the equation OPT.1 is defined as the problem of finding the assignment of values to variables x1, x2, x3, and x4 such that the constraints (2), (3), and (4) are all satisfied, and minimizes the equation OPT.1.

In the equation OPT.1, there are only three ways to assign values to x1, x2, x3, x4 that satisfy the constraints (2), (3), (4), i.e., (x1, x2, x3, x4)={(1, 1, 0, 0), (1, 1, 0, 1), (0, 0, 1, 1)}. When (x1, x2, x3, x4) is (1, 1, 0, 0) out of three ways, the objective function (1) has the smallest value, with a value of 3. The aforementioned assignment (x1, x2, x3, x4)=(1, 1, 0, 0) and the minimum value 3 of the objective function are the optimal solutions to the equation OPT.1.

The above is a description of a constrained binary optimization problem with a specific example.

It is known that it takes a very long time to calculate the optimal solution for some combinatorial optimization problems using a conventional general-purpose computer so-called Neumann-type computer. Such disadvantage is also applied to the constrained binary optimization problem.

Therefore, attempts have been made to solve combinatorial optimization problems more efficiently with devices that have a different operating principle from the Neumann-type computer. In the following, such devices are simply called “optimization specialization devices”.

One example of an optimization specialization device is an annealing machine that uses a natural phenomenon called “annealing”. This is a device that artificially reproduces and utilizes in hardware the annealing phenomenon, i.e., the process of a natural phenomenon in which a state with a high energy level transitions to another state (called a stable state) with a lower energy level in a sufficient amount of time.

Directly, the annealing machine is only a device to calculate “how is the stable state of the input physical model”. However, some combinatorial optimization problems can be mapped to the input of a problem that can be solved by the annealing machine, and the solution to the original problem can be obtained on the basis of a result of the annealing machine. By the above means, some combinatorial optimization problems can be solved more efficiently than a general-purpose Neumann-type computer to obtain the optimal solution.

### CITATION LIST

### Patent Literature

Patent Literature 1: Japanese Patent No. 5922203

### Non-Patent Literature

Non-Patent Literature 1: Michael Booth et al., Partitioning Optimization Problems for Hybrid Classical/Quantum Execution, D-Wave Technical Report Series, January 2017.
Non-Patent Literature 2: Andrew Lucas, Ising formulations of many NP problems, Frontiers in Physics, vol. 2, February 2014.
Non-Patent Literature 3: Kotaro Tanahashi et al., Application of Ising Machines and a Software Development for Ising Machines, Journal of the Physical Society of Japan, vol 88, May 2019.

### SUMMARY

The problem of the present invention is to make it possible to handle even a problem beyond the problem of “constraints on the coefficients, which are specific to the optimization specialization device” with the same optimization specialization device.

In one aspect of the present invention, an information processing device that outputs an optimal solution to a binary optimization problem when the binary optimization problem including a linear inequality constraint represented by at least a linear inequality is input, includes a constraint transformation unit which transforms the constraint to a constraint represented by the linear inequality with a coefficient size smaller than the coefficient size of the linear inequality, and an optimization unit which calculates the optimal solution of the binary optimization problem on the basis of the constraint including the linear inequality transformed by the constraint transformation unit.

In one aspect of the present invention, an information processing method that outputs the optimal solution to a binary optimization problem when the binary optimization problem including a linear inequality constraint represented by at least a linear inequality is input, includes transforming the constraint to a constraint represented by the linear inequality with a coefficient size smaller than the coefficient size of the linear inequality, and calculating the optimal solution of the binary optimization problem on the basis of the constraint including the transformed linear inequalities.

In one aspect of the present invention, a computer-readable recording medium recording an information processing program for outputting an optimal solution to a binary optimization problem when the binary optimization problem including a linear inequality constraint represented by at least a linear inequality is input, when executed by a computer, performs transforming the constraint to a constraint represented by the linear inequality with a coefficient size smaller than the coefficient size of the linear inequality, and calculating the optimal solution of the binary optimization problem on the basis of the constraint including the transformed linear inequalities.

### BRIEF DESCRIPTION OF DRAWINGS

FIG. 1 It depicts a block diagram showing an example of an information processing device of the first example embodiment.

FIG. 2 It depicts a flowchart showing an example of the operation of the information processing device of the first example embodiment.

FIG. 3 It depicts a flowchart showing an example of the operation of the inequality constraint transformation unit of the first example embodiment.

FIG. 4 It depicts a block diagram showing an example of an information processing device of the second example embodiment.

FIG. 5 It depicts a block diagram showing an example of an information processing device of the third example embodiment.

FIG. 6 It depicts a flowchart showing an example of the operation of the inequality constraint transformation unit of the third example embodiment.

FIG. 7 It depicts a block diagram showing an example of an information processing device of the fourth example embodiment.

FIG. 8 It depicts a flowchart showing an example of the operation of the inequality constraint transformation unit of the fourth example embodiment.

FIG. 9 It depicts a flowchart showing an example of the operation of the inequality constraint transformation unit of the fourth example embodiment.

FIG. 10 It depicts a block diagram showing an example of a computer with a CPU.

FIG. 11 It depicts a block diagram of the main part of the information processing device.

### DESCRIPTION OF EMBODIMENTS

The following is a description of the problem to be solved by this invention.

A device that directly utilizes natural phenomena, such as an annealing machine, is generally difficult to control. Therefore, the scale of natural phenomena that can be reproduced on hardware is severely limited by technical limitation. For the same reason, the scope of the problem that can be handled by an optimization specialization device tends to be more strongly restricted than that of the Neumann-type computer.

The aforementioned restriction not only limits the scope of the problem that can be input, but also may limit the parameters associated with the problem. The restriction is explained below.

First, the restriction on the parameters related to the problem will be explained in detail on the basis of a real problem example.

The following are three constraints C1, C2, and C3 pertaining to Boolean variables.

(C1)=“x1+2*x2+x3≤2”

(C2)=“x1+x2+x3+ . . . +x100≤30”

(C3)=“112345*x1+113579*x2+112345*x3≤225000”

The constraint C1 is an example of a very simple constraint consisting of three variables x1, x2, and x3, and the representation of the problem is concise. Even though the input is highly restricted, this kind of constraint can be used without any problem.

On the other hand, the constraint C2 consists of as many as 100 variables x1, x2, . . . , x100. The constraint C2 is a larger constraint than C1. Such a constraint cannot be input to an annealing machine that is limited to less than 50 Boolean variables that it can handle, for example.

The last constraint C3 is a constraint consisting of three variables, just like C1, and is as simple as a constraint as C1.

However, in the constraint C3, has large values of constants that appear compared to the constraint C1. The largest constant in the constraint C1 is 2, while in the constraint C3 it is 225000. As can be seen by comparing the representations as decimal numbers, problems with larger coefficients also require a larger data area for their representation. Therefore, when there is a technical upper limit to the size of data that can be input to the optimization specialization device, such constraints cannot be input either.

The above is a description of the restrictions on the parameters related to the problem.

Next, “restrictions on the problem that can be input to the optimization specialization device” will be explained on the basis of a specific example. Here, such a case where an annealing machine is selected as the specific optimization specialization device will be described.

In the case of the annealing machine, the aforementioned constraint on the size of the data that can be input involves the concept of “precision” (of the interaction between variables).

Intuitively, the size of the coefficient in the inequality constraint indicates how much influence the variable it pertains to has “compared to other variables”. For example, in the constraint C1, the coefficient of variable x2 is twice as large as the coefficient of variable x1, indicating that the impact of variable x2 is twice as large as that of variable x1.

Although there are several ways to map inequality constraints to an annealing machine, at least the “size of influence between variables” as described above needs to be reproduced on the hardware of the annealing machine.

The size of the influence between variables in the annealing machine is expressed by the setting item “how much strength each variable interacts with each other”. The values that can be set here are discrete and vary depending on the hardware, such as four levels of “−2, −1, 0, 1”, two levels of “0, 1”, and 512 levels of “−256 to 255”. The number of steps that can be set by hardware is called the “precision”.

In other words, the number of hardware-specific “precisions” limits the size of the coefficients (absolute values of) the inequality constraints that can be handled.

In fact, the value of the precision is very small, depending on the hardware. For example, the device with three precisions: −1, 0, and 1 is described in the patent literature 1. For this kind of hardware, the possible input problems are extremely limited.

The above is a specific description of the “constraint on the problems that can be input to the optimization specialization device”.

To summarize the explanation so far, the optimization specialization device has constraint on the coefficients of the inequality constraints that can be input, and this constraint depends on and is determined by a hardware-specific value (in the case of the annealing machine, the value of “precision”).

The problem of the present invention is to make it possible to handle even a problem beyond the problem of the aforementioned “constraints on the coefficients, which are specific to the optimization specialization device” with the same optimization specialization device.

Incidentally, there is a method of inputting an approximate problem to solve a problem with constraint that cannot be input to the optimization specialization device M by the optimization specialization device M.

For example, suppose that the optimization specialization device M can only take 256 values from −128 to 127 as coefficients of inequality constraint. In this situation, the inequality constraint C3 is an example of an inequality constraint that “cannot be handled directly,” but by multiplying each coefficient by 128/22500 and rounding, an input-ready inequality constraint C3′ can be obtained.

C3′=“63*x1+64*x2+63*x3≤127”

This method makes it possible to input constraint similar to the constraint C3, but for example, the assignment of values to variables (x1, x2, x3)=(1, 1, 0) satisfies the constraint C3 but not the constraint C3′. Therefore, in the first place, these inequality constraints are completely different constraints with different satisfaction domains, thus such a method of “approximation” cannot solve the problem of the present invention.

### Example Embodiment 1

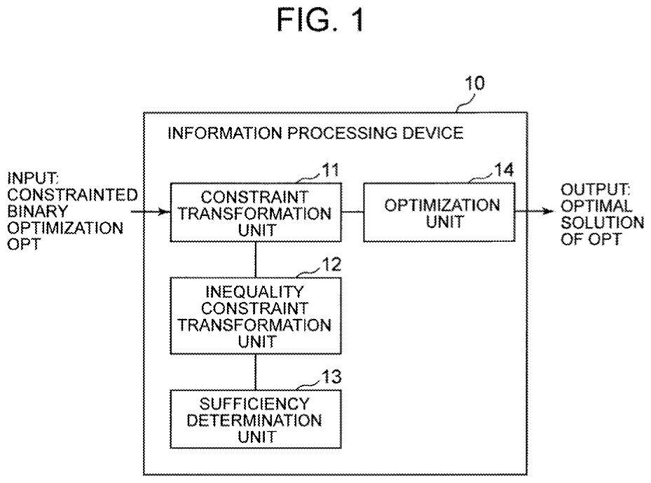

Hereinafter, the first example embodiment of the present invention will be described with reference to the drawings. FIG. 1 is a block diagram showing an example of an information processing device 10 of the first example embodiment. The information processing device 10 of the first example embodiment includes four processing blocks described in FIG. 1. That is, the information processing device 10 includes a constraint transformation unit 11, an inequality constraint transformation unit 12, a sufficiency determination unit 13, and an optimization unit 14.

The constraint transformation unit 11 receives as input a constrained binary optimization problem including linear inequality constraint represented by a linear inequality, and outputs a constrained binary optimization problem obtained by transforming the linear inequality constraint in the input into another equivalent linear inequality constraint that can be expressed with less data size.

The inequality constraint transformation unit 12 receives a linear inequality constraint as input and outputs another equivalent linear inequality constraint consisting only of coefficients that can be expressed with less data size.

The sufficiency determination unit 13 receives the constraint equation from the inequality constraint transformation unit 12 as input, and if there is an assignment of values to the variables that satisfy it, the sufficiency determination unit 13 judges it to be “satisfiable” and outputs the combination of values. If there is no such combination of values, the sufficiency determination unit 13 judges it to be “unsatisfiable”.

The optimization unit 14 receives a constrained binary optimization problem including a linear inequality transformed by the constraint transformation unit 11, obtains its solution, and outputs the solution.

The following is a more detailed definition of the “data size of the coefficients” of the inequality constraint in the present invention. In the following, the values of the coefficients and constant terms will be discussed as integers, but even if they are decimal numbers, they can be treated the same as integers by multiplying both sides by appropriate constants (for example, the inequality constraint of 0.4*x1+0.3*x2≤1.0 can be transformed to an inequality constraint of integer coefficients of 4*x1+3*x≤10 by multiplying both sides by 10).

There are four possible types of inequality constraints: “constraint (1) left side≤right side”, “constraint (2) left side≥right side”, “constraint (3) left side<right side”, and “constraint (4) left side>right side”. However, constraints (2) and (4) can be transformed to the types of constraints (1) and (3) respectively by multiplying both sides by −1.

The inequality constraint of the type of constraint (3) can also be transformed to the type of constraint (1). To illustrate this, consider the following inequality constraint C.T3 of type constraint (3).

C.T3=“c1*x1+c2*x2+ . . . +cn*xn≤c”

Consider the following inequality constraint C.T1, where the “<” part of C.T3 is replaced by “≤”.

C.T1=“c1*x1+c2*x2+ . . . +cn*xn≤c”

The satisfaction domain of the inequality constraint C.T1 is the domain of the inequality constraint C.T3 plus the equality constraint “c1*x1+c2*c2+ . . . +cn*xn=c”. Here, the following inequality constraint C.T1′ is generated by subtracting ½ from the right side of the inequality constraint C.T1 so that only the satisfaction domain of this equality constraint is removed from C.T1. Since the value subtracted from the right side is less than 1, this operation does not cause assignments included in the satisfaction domain to go out of the satisfaction domain or conversely, assignments outside the satisfaction domain to enter the satisfaction domain.

C.T1′=c1*x1+c2*x2+ . . . +cn*xn≤c−½

Since the inequality constraint C.T1′ has the same satisfaction domain as the inequality constraint C.T3, an inequality constraint is obtained that is exactly equal as a constraint but of constraint type (1). Furthermore, by doubling both sides, an inequality constraint with integer coefficients is obtained “such that it is equivalent to inequality constraint C.T3 and is of constraint type (1)” as shown below.

2*c1*x1+2*c2*x2+ . . . +2*cn*xn≤2*c−1

By the above explanation, all inequality constraints can be expressed as a type of constraint (1). Therefore, the “coefficient size” of an inequality constraint can be defined as follows. The coefficient size of the equality constraint “c1*x1+c2*x2+ . . . +cn*xn≤c” is the minimum number of bits required to represent all c1, c2, . . . , cn and c. In addition, integers from −2^{b}) to 2^{b}−1 can be represented with b bits.

For example, the inequality constraint (4) in the constrained binary optimization problem OPT.1 requires 3 bits to represent the constant term 4, thus the coefficient size of the inequality constraint (4) is 3.

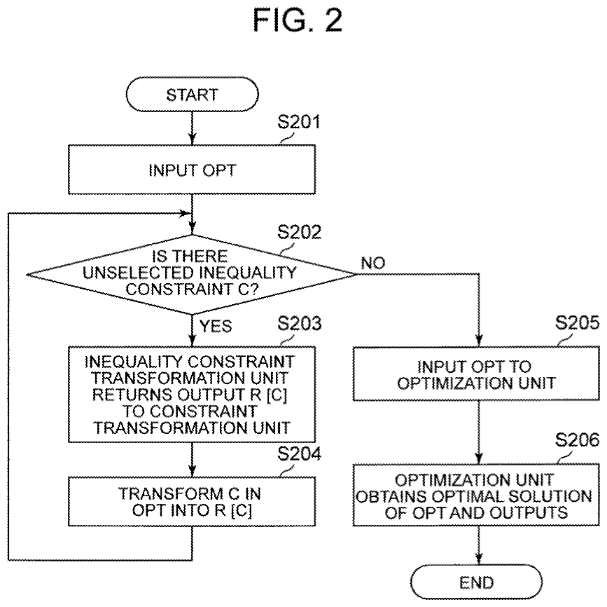

Next, the operation of calculating the solution of a constrained binary optimization problem by the information processing device 10 of the first example embodiment will be explained using FIG. 2.

FIG. 2 shows a flowchart of the information processing device 10 calculating a solution to an input constrained binary optimization problem.

First, a constrained binary optimization problem is input to the constraint transformation unit 11 through an input/output device (not shown) in the information processing device 10 (Step S201).

Next, the constraint transformation unit 11 inputs each inequality constraint C to the inequality constraint transformation unit 12, one by one, if there is an inequality constraints C in the input constrained binary optimization problem (Step S202).

The inequality constraint transformation unit 12 returns the inequality constraint R [C], which is equivalent to the input inequality constraint C and has a smaller coefficient size, to the constraint transformation unit 11 (Step S203).

The constraint transformation unit 11 transforms the original inequality constraint C into the inequality constraint R [C] transformed by the inequality constraint transformation unit 12 (Step S204).

The constraint transformation unit 11 inputs the constrained binary optimization problem to the optimization unit 14 when all inequality constraints have been transformed (Step S205).

The optimization unit 14 obtains the optimal solution to the input constrained binary optimization problem and outputs it as the optimal solution to the original problem (Step S206).

The above is a description of the operation of the information processing device 10.

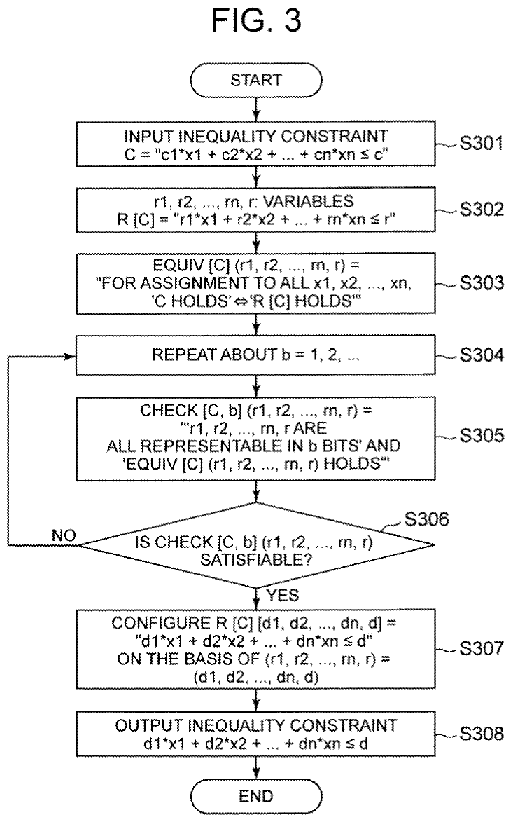

Next, the operation of the inequality constraint transformation unit 12 of the first example embodiment, which transforms inequality constraints to inequality constraints with smaller coefficient sizes, is explained using FIG. 3.

FIG. 3 shows the flowchart of the inequality constraint transformation unit 12 transforming the input inequality constraints into inequality constraints with smaller coefficient sizes.

First, the inequality constraint transformation unit 12 receives the inequality constraintC=“c1*x1+c2*x2+ . . . +cn*xn≤c” as input from the constraint transformation unit 11 (Step S301). x1, . . . , xn are variables, and c1, cn, c are constants (specific numbers).

Next, the inequality constraint transformation unit 12 newly introduces n+1 variables r1, r2, . . . , rn, r, and generates the constraint equation R [C]=“r1*x1+r2*x2+ . . . +m*xn≤r” (Step S302). In the constraint equation R [C], the constraint transformation unit 12 determines the value assignment (r1, r2, . . . , rn, r)=(d1, d2, . . . , dn, d). In this way, the original inequality constraint C is transformed into the inequality constraint R [C] [d1, . . . , dn, d]=“d1*x1+d2*x2+ . . . +dn*xn≤d” on the variables x1, . . . , xn.

Next, the inequality constraint transformation unit 12 combines the inequality constraint C with the constraint equation R [C] to configure the following constraint EQUIV (r1, . . . , rn, r) for variables r1, . . . , m, r.

EQUIV (r1, . . . , rn, r)=“For an assignment to all x1, x2, . . . , xn, ‘the inequality constraint C holds’ ⇔ ‘the constraint equation R [C] holds’” (Step S303).

The following explains what it means for the assignment (r1, r2, . . . , m, r)=(d1, d2, . . . , dn, d) of values to variables r1, . . . , m, r satisfies the constraint EQUIV (r1, . . . , rn, r). As mentioned above, the constraint equation R [C] is now the inequality constraint R [C] [d1, . . . , dn, d]=“d1*x1+d2*x2+ . . . +dn*xn≤d” on the variables x1, . . . , xn. Therefore, the following proposition EQUIV [d1, . . . , dn, d] holds. This also can be interpreted as a relationship between the two inequality constraints C and R [C] [d1, . . . , dn, d].

EQUIV [d1, . . . , dn, d]=“For an assignment to all x1, x2, . . . , xn, ‘the inequality constraint C holds’ ⇔ ‘the inequality constraint R [C] [d1, . . . , dn, d] holds’”.

In other words, the fact that the proposition EQUIV [d1, . . . , dn, d] is true means that “it is equivalent that the assignment to a certain x1, . . . , xn satisfies the inequality constraint C and the inequality constraint R [C] [d1, . . . , dn, d]”. This means that the satisfaction domains of these two inequality constraints are equal. Therefore, when the proposition EQUIV [d1, . . . , dn, d] holds, the inequality constraint C and the inequality constraint R [C] [d1, . . . , dn, d] are equivalent.

The above is an explanation of what it means for a value assignment (r1, r2, . . . , rn, r)=(d1, d2, . . . , dn, d) to satisfy the constraint EQUIV (r1, . . . , m, r).

From the above, if a value assignment (r1, r2, . . . , rn, r)=(d1, d2, . . . , dn, d) that satisfies the constraint EQUIV (r1, . . . , m, r) is obtained, an inequality constraint R [C] [d1, . . . , dn, d] that is equivalent to the original inequality constraint C on the basis of their assignment is obtained. Therefore, in the steps after step S304 in FIG. 3, a procedure to calculate the assignment of values to variables r1, r2, . . . , m, r that satisfies the constraint EQUIV (r1, . . . , m, r) is implemented.

The inequality constraint transformation unit 12 increases the value of the variable b from b=1 to b=2, 3, . . . and repeatedly executes step S305 and step S306 (Step S304).

In step S305, the inequality constraint transformation unit 12 configures the following constraint CHECK [C, b] (r1, . . . , rn, r) on the basis of the constraint EQUIV (r1, . . . , m, r).

CHECK [C, b] (r1, . . . , rn, r)=“‘r1, . . . , m, r are all representable in b bits' and ′EQUIV (r1, . . . m, r) holds’”.

The meaning of the constraint CHECK [C, b] (r1, . . . , rn, r) is explained.

The constraint CHECK [C, b] (r1, . . . , rn, r) is a constraint that is obtained by adding the condition “All of them are less than or equal to b bits” as a condition which the valuables r1, m, r satisfy to the constraint EQUIV (r1, . . . , m, r).

Together with the meaning of the above constraint EQUIV (r1, . . . , m, r), what the value assignment (r1, . . . , m, r)=(d1, . . . , dn, d) satisfies the constraint CHECK [C, b] (r1, . . . , rn, r) means that “d1, . . . , dn, and d are all integer values that can be expressed in b bits, and d1*x1++dn+xn≤d is equivalent to inequality constraint C”. Furthermore, that means “d1*x1+ . . . +dn*xn≤d is equivalent to inequality constraint C and the coefficient size is less than or equal to b”.

That is, if there exists an assignment (r1, r2, . . . , rn, r)=(d1, d2, . . . , dn, d) that satisfies the constraint CHECK [C, b] (r1, . . . , m, r), then an inequality constraint R [C] [d1, . . . , dn, d] that is equivalent to the inequality constraint C and whose coefficient size is less than or equal to b would be obtained.

On the contrary, if there not exists an assignment (r1, r2, . . . , rn, r)=(d1, d2, . . . , dn, d) that satisfies the constraint CHECK [C, b] (r1, . . . , m, r), then the inequality constraint that is equivalent to the inequality constraint C and whose coefficient size is less than or equal to b does not exist.

The above is an explanation of the meaning of the constraint CHECK [C, b] (r1, . . . , m, r).

The inequality constraint transformation unit 12 inputs the constraint CHECK [C, b] (r1, . . . , m, r) to the sufficiency determination unit 13. If the result of the sufficiency determination unit 13 is “satisfiable,” the process proceeds to step S307 (Step S306). If the result of the sufficiency determination unit 13 is “unsatisfiable”, the process returns to step S304 (Step S306).

In step S307, the inequality constraint transformation unit 12 configures the inequality constraint R [C] [d1, . . . , dn, d] on the basis of the value assignment (r1, r2, . . . , m, r)=(d1, d2, dn, d) output from the sufficiency determination unit 13 and output the result.

The above is an explanation of the operation of transforming an inequality constraint to another inequality constraint with smaller coefficient sizes of the inequality constraint transformation unit 12 in the first example embodiment.

The following explains the specific operation of the inequality constraint transformation unit 12 in the first example embodiment using a specific example of inequality constraint.

The operation when the inequality constraint C3 is given as a specific input is described below. The inequality constraint C3 is the following inequality constraint, and its coefficient size is 18.

C3=“112345*x1+113579*x2+112345*x3≤225000”

In contrast, the inequality constraint transformation unit 12 prepares four variables r1, r2, r3, and r in step S302, and generates the following constraint equation R [C3].

R[C3]=“r1*x1+r2*x2+r3*x3≤r”

Then, the inequality constraint transformation unit 12 configures the following constraint EQUIV [C3] (r1, r2, r3, r) in step S303.

EQUIV [C3] (r1, r2, r3, r)=“For an assignment to all x1, x2, x3, ‘C3 holds’ ⇔ ‘R [C3] holds’”.

The process then enters a repeat procedure from step S304. First, the inequality constraint transformation unit 12 inputs the following constraint CHECK [C3, 1] (r1, r2, r3, r) to the sufficiency determination unit 13 as b=1.

CHECK [C3, 1] (r1, r2, r3, r)=“all of r1, r2, r3, r are −1 or 0” and “EQUIV [C3] (r1, r2, r3, r) holds”

Since there are no assignment of values to r1, r2, r3, and r that satisfies CHECK [C3, 1] (r1, r2, r3, r), the sufficiency determination unit 13 returns “unsatisfiable” to the inequality constraint transformation unit 12.

Next, the inequality constraint transformation unit 12 inputs the following constraint CHECK [C3, 2] (r1, r2, r3, r) to the sufficiency determination unit 13 as b=2.

CHECK [C3, 1] (r1, r2, r3, r)=“all of r1, r2, r3, r are −2, −1, 0, or 1” and “EQUIV [C3] (r1, r2, r3, r) holds”

Since there are no assignment of values to r1, r2, r3, and r that satisfies the constraint CHECK [C3, 1] (r1, r2, r3, r), the sufficiency determination unit 13 returns “unsatisfiable” to the inequality constraint transformation unit 12.

Next, the inequality constraint transformation unit 12 inputs the following constraint CHECK [C3, 3] (r1, r2, r3, r) to the sufficiency determination unit 13 as b=3.

CHECK [C3, 1] (r1, r2, r3, r)=“all of r1, r2, r3, r are between −4 and 3” and “EQUIV

[C3] (r1, r2, r3, r) holds”

There exists (r1, r2, r3, r)=(1, 2, 1, 2) as a value assignment that can satisfy CHECK [C3, 1] (r1, r2, r3, r). Therefore, the sufficiency determination unit 13 returns the aforementioned value assignment to the inequality constraint transformation unit 12 along with “satisfiable”.

In step S307, the inequality constraint transformation unit 12 uses the value assignment (r1, r2, r3, r)=(1, 2, 1, 2) returned from the sufficiency determination unit 13, and outputs the inequality constraint “x1+2*x2+x3≤2” as a result to the constraint transformation unit 11.

The coefficient size value of the above inequality constraint is 3, which is smaller than the coefficient size value of inequality constraint C3, which is 18. Furthermore, since the satisfaction domains of both of these two inequality constraints are (x1, x2, x3)={(0, 0, 0), (1, 0, 0), (0, 0, 1), (0, 1, 0), (1, 0, 1)}, they are equivalent inequality constraints.

The above is an explanation of the specific operation of the inequality constraint transformation unit 12 in the first example embodiment using the specific inequality constraint example C3.

Next, the operation of the sufficiency determination unit 13 will be explained. As described above, the sufficiency determination unit 13 obtains an assignment of the values to the variables r1, . . . , rn, r that satisfies the constraint equation CHECK [C, b] (r1, . . . , m, r) input from the inequality constraint transformation unit 12.

The method by which the sufficiency determination unit 13 calculates the assignment of values to integer type variables is not particularly limited and can be done by any known method. In the following, some specific methods of calculating the value assignment by known methods are shown.

The first method is to use a constraint solver that can directly solve the constraint equation CHECK [C, b] (r1, . . . , rn, r). Since the constraint equation CHECK [C, b] (r1, . . . , m, r) is formally a constraint equation for quantified integer variables, a constraint solver that can solve it directly can be used to obtain the value assignment to variables r1, . . . , rn, r.

The second method is to expand the constraint equation CHECK [C, b] (r1, . . . , rn, r) into “a conjunction of multiple inequality constraints”. The satisfaction domain of inequality constraint C is (x1, x2, . . . , xn)={(v1 [1], v2 [1], . . . , vn [1]), (v1 [2], v2 [2], . . . , vn [2]), . . . , (v1 [m], v2 [m], . . . , vn [m])}. If then pairs of 0, 1 that are not included here are {(u1 [1], u2 [1], . . . , un [1]), (u1 [2], u2 [2], . . . , un [2]), (u1 [k], u2 [k], . . . , un [k])}, the constraint equation CHECK [C, b] (r1, . . . , m, r) is equivalent to the following conjunction of an inequality constraint.

CHECK [C, b] (r1, . . . , rn, r)=“−2^{b}≤r1” and “r1≤2^{b}−1” and “−2^{b}≤r2” and “r2≤2^{b}−1” and . . . “−2^{b}≤m” and “m≤2^{b}−1” and “−2^{b}≤r” and “r≤2^{b}−1” and “r1*v1 [1]+ . . . +m*vn [1]≤r” and . . . , “r1*v1 [m]+ . . . +rn*vn [m]≤r” and “r1*u1 [1]+ . . . +rn*un [1]>r” and . . . , “r1*u1 [k]+ . . . +rn*un [k]>r”

Through the above formalization, the sufficiency determination unit 13 can obtain the value assignment to the variables r1, . . . , rn, r by a solver that can solve a conjunction of integer inequality constraints that does not correspond to the quantification of the variables.

The third method is to resolve the above variables r1, r2, . . . , m, r into Boolean variables and transform all variables into Boolean variables. The details are omitted, but the values of r1, m, r that satisfy the constraint equation CHECK [C, b] (r1, . . . , rn, r) from the definition is always represented by b bits. Therefore, the sufficiency determination unit 13 can encode the bit representation itself by using b Boolean variables for the variable ri.

For example, assuming that the variable ri can be expressed in 4 bits, the sufficiency determination unit 13 can prepare four Boolean variables ri [1], ri [2], ri [3], and ri [4] for the variable ri, and replace the variable ri with the following terms.

ri[4]*8+ri[3]*4+ri[2]*2+ri[1]

By expressing everything in terms of Boolean variables in this way, all variables in the constraint equation CHECK [C, b] (r1, . . . , rn, r) are Boolean variables (including the quantified x1, . . . , xn).

It is known to solve a problem where all of the variables are Boolean variables and the coefficients include numerical values by replacing the problem into SAT (satisfiability problem). Therefore, by further replacing the above transformed problem to SAT, the sufficiency determination unit 13 can obtain the value assignment by the known SAT solving technique.

The above is a specific explanation of a method using known methods that the sufficiency determination unit 13 can use to obtain the assignment of values to variables r1, . . . , rn, r.

The optimization unit 14 in the first example embodiment receives a constrained binary optimization problem as input and uses an optimization specialization device to obtain the optimal solution and output it.

The method by which the optimization unit 14 in the first example embodiment uses an optimization specialization device to obtain the optimal solution to a constrained binary optimization problem is not limited, and any known method can be used. For example, non-patent literature 3 describes a method for solving an optimization problem with an inequality constraint using an Ising machine, which is one of the optimization specialization devices. This method may be used as an implementation of the optimization unit 14.

As explained above, the information processing device 10 of the first example embodiment performs optimization by the optimization unit 14 after transforming the input constrained binary optimization problem into an equivalent and a smaller coefficient size constrained binary optimization problem. As a result, the information processing device 10 of the first example embodiment can obtain an optimal solution even for a binary optimization problem for which an optimal solution cannot be obtained directly due to the original hardware constraint.

### Example Embodiment 2

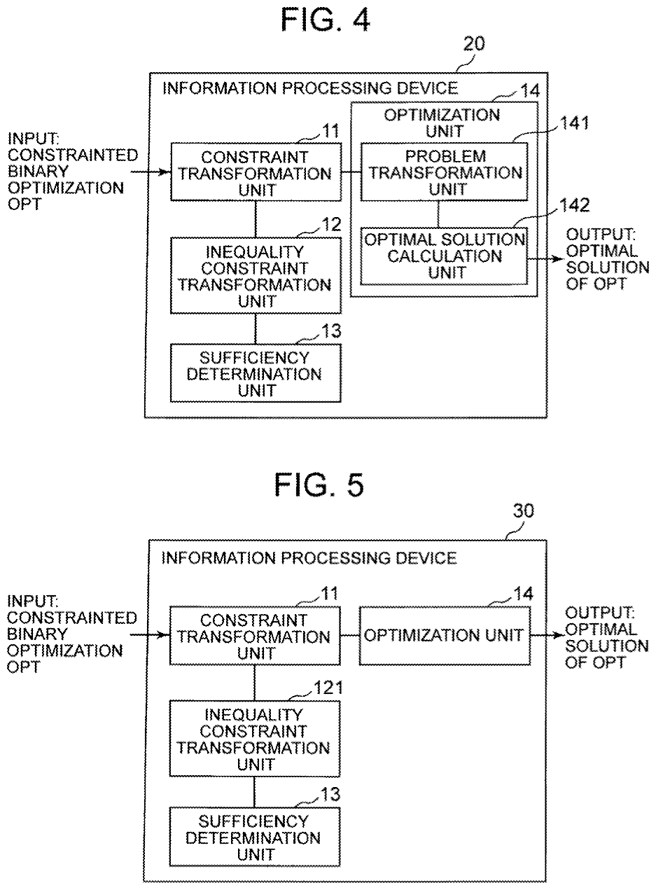

Hereinafter, the second example embodiment of the present invention will be described with reference to the drawings. FIG. 4 is a block diagram showing an example of the information processing device 20 of the second example embodiment. The information processing device 20 of the second example embodiment includes four processing blocks described in FIG. 4. That is, the information processing device 20 includes a constraint transformation unit 11, an inequality constraint transformation unit 12, a sufficiency determination unit 13, and an optimization unit 14.

The information processing device 20 shares most of the same features as the information processing device 10. However, the optimization unit 14 consists of two devices, the problem transformation unit 141 and the optimal solution calculation unit 142.

The operation of the information processing device 20 of the second example embodiment will be described. The configuration of the information processing device 20 of the second example embodiment is the same as that of the information processing device 10, except that the optimal solution of the constrained binary optimization problem is obtained using the optimization unit 14, which consists of two devices, i.e., the problem transformation unit 141 and the optimal solution calculation unit 142.

The operation of the optimization unit 14 of the second example embodiment is described below. The optimization unit 14 of the second example embodiment first inputs the input constrained binary optimization problem to the problem transformation unit 141. The optimization unit 14 then outputs the output returned from the problem transformation unit 141 through the optimal solution calculation unit 142 as the optimal solution of the equation OPT.

The problem transformation unit 141 transforms the input constrained binary optimization problem into an equivalent quadratic unconstrained binary optimization (QUBO) problem and inputs it to the optimal solution calculation unit 142. Furthermore, the optimization unit 14 receives the output returned from the optimal solution calculation unit 142, transforms it to the solution of the original constrained binary optimization problem, and then outputs it.

The method by which the problem transformation unit 141 transforms a constrained binary optimization problem into a quadratic unconstrained binary optimization problem is not limited to any particular method, and any known method can be used. An example of a specific method for transforming a constrained binary optimization problem into a quadratic unconstrained binary optimization problem is described below by illustrating the procedure for transforming a specific problem. This method is similar to the method introduced in the non-patent literature 2 as a way to transform the “Knapsack with Integer Weight” problem into a quadratic unconstrained binary optimization problem.

The method described below is effective only when the optimization problem includes only terms of second or lower order and the constraint equation (equation or inequality) is linear.

Suppose that the following problem OPT.2 is input to the problem transformation unit 141. The problem OPT.2 consists of objective function OBJ, equality constraint EQ, and inequality constraint IEQ.

(OPT.2)

### [Objective Function]

x1+2*x2+3*x3 (OBJ)

### [Constraints]

x1+x2=1 (EQ)

2*x1+2*x2+3*x3≤5 (IEQ)

First, the problem transformation unit 141 transforms each constraint equation into an “auxiliary objective function” such that “the constraint equation holds ⇔ the value of the auxiliary objective function is minimum” and “the constraint equation does not hold ⇔ the value of the auxiliary objective function is greater than or equal to 1” holds.

First, an equality constraint is described. When the equality constraint EQ is transformed to “x1+x2−1=0”, the fact that this equation is valid is equivalent to the fact that the auxiliary objective function “(x1+x2−1)²” obtained by squaring the left side takes the minimum value. In addition, when the constraint equation does not hold, the value of the auxiliary objective function takes a value greater than or equal to 1.

Next, an inequality constraint is described. Since the expression “the value of 2*x1+2*x2+3*x3 is either 0, 1, 2, 3, 4, or 5” can be used instead of the inequality constraint IEQ, by introducing new Boolean variables c1, c2, c3, c4, c5, and c6, the following equality constraint that is equivalent to the inequality constraint IEQ can be obtained.

IEQ′=“2*x1+2*x2+3*x3−c1−c2−c3−c4−c5−c6=0”

Therefore, this has the same value as it of the equality constraint EQ as well as the auxiliary objective function “(2*x1+2*x2+3*x3−c1−c2−c3−c4−c5−c6)²”. In addition, when the constraint equation does not hold, the value of the auxiliary objective function takes a value greater than or equal to 1.

The above is an explanation of the method transforming each constraint equation into an objective function by the problem transformation unit 141.

Next, the method of combining all objective functions including the original objective function OBJ into one by the problem transformation unit 141 will be explained.

First, if the upper bound of the objective function OBJ when ignoring constraint is considered, it is obviously 6 when 1 is assigned to all variables.

Then, the original objective function is left as it is, and the auxiliary objective function generated by transforming the constraints is multiplied by “7”, and added together to obtain the following quadratic unconstrained binary optimization problem OPT-UC.

(OPT-UC)

x1+2*x2+3*x3+7*(x1+x2−1)²+7*(2*x1+2*x2+3*x3−c1−c2−c3−c4−c5−c6)²

The resulting value assignment that minimizes the objective function of the aforementioned quadratic unconstrained binary optimization problem gives the optimal solution to the original optimization problem OPT.2. This is explained in the following.

The auxiliary objective function takes a value greater than or equal to 1 when its original constraint equation is not satisfied. If the value assignment (x1, x2, x3)=(v1, v2, v3) satisfies all of the original constraint equations, the value of the binary optimization problem OPT-UC will be 6 or less. Conversely, if there is even one constraint equation that is not satisfied, the value of the binary optimization problem OPT-UC will be 7 or higher. Therefore, any value assignment that gives the minimum value of the binary optimization problem OPT-UC will always satisfy all the constraints that the problem OPT.2 has.

In other words, the binary optimization problem OPT-UC will take the minimum value in the value assignment that minimizes the value of the original objective function among the value assignments such that the value of the auxiliary objective function is zero. Therefore, the value assignment that would give the optimal solution to the binary optimization problem OPT-UC will give the optimal solution to problem OPT.2.

The above is a description of an example of the specific way in which the problem transformation unit 141 transforms a constrained binary optimization problem into a quadratic unconstrained binary optimization problem.

The way in which the problem transformation unit 141 configures the optimal solution to the original problem on the basis of the solution returned to the optimal solution calculation unit 142 depends on the method adopted in the immediately preceding step, i.e., the method of transforming a constrained binary optimization problem to a quadratic unconstrained binary optimization problem.

Specifically, suppose that the problem transformation unit 141 transforms the problem OPT.2 into the binary optimization problem OPT-UC and inputs it to the optimal solution calculation unit 142, for example, the value assignment (x1, x2, x3, c1, c2, c3, c4, c5, c6)=(1, 0, 0, 1, 1, 0, 0, 0, 0) is obtained.

In the above case, since the value assignment for the variables x1, x2, x3 of the original problem OPT.2 is included in the above assignment, the solution (x1, x2, x3)=(1, 0, 0) of problem OPT.2 can be configures just by extracting it.

The above is a specific description of the operation of the problem transformation unit 141.

The method by which the optimal solution calculation unit 142 obtains the optimal solution of a quadratic unconstrained binary optimization problem is not limited to any particular method and can be a known one. For example, a method using a quantum annealing machine, which is a kind of annealing machine mentioned in the description above, is described in non-patent literature 1. With this method, the optimal solution calculation unit 142 can calculate the optimal solution to the input quadratic unconstrained binary optimization problem. In other words, the optimization specialization device described above can be used as the optimal solution calculation unit 142.

As explained above, the information processing device 20 of the second example embodiment transforms the input constrained binary optimization problem into a quadratic unconstrained binary optimization problem using the problem transformation unit 141 after transforming the input constrained binary optimization problem into an equivalent constrained binary optimization problem with a smaller coefficient size.

As a result, the information processing device 20 of the second example embodiment can transform the original constrained binary optimization problem into a problem with a smaller coefficient size than directly transforming the original constrained binary optimization problem into a quadratic unconstrained binary optimization problem using the problem transformation unit 141. Therefore, the information processing device 20 of the second example embodiment can calculate an optimal solution to an optimization problem for which the optimal solution cannot be calculated directly by the optimal solution calculation unit 142 due to original hardware constraints.

### Example Embodiment 3

Hereinafter, the third example embodiment of the present invention will be described with reference to the drawings. FIG. 5 is a block diagram showing an example of the information processing device 30 of the third example embodiment. The information processing device 30 of the third example embodiment includes four processing blocks described in FIG. 5. That is, the information processing device 30 includes a constraint transformation unit 11, an inequality constraint transformation unit 121, a sufficiency determination unit 13, and an optimization unit 14.

The information processing device 30 shares most of the same features as the information processing device 10, but instead of the inequality constraint transformation unit 12, an inequality constraint transformation unit 121 with different operation is connected.

The operation of the information processing device 30 of the third example embodiment will be described. The configuration of the information processing device 30 of the third example embodiment is the same as that of the information processing device 10, except that the inequality constraint transformation unit 121 is used instead of the inequality constraint transformation unit 12 to transform inequality constraint.

However, as described below, in the information processing device 30 of the third example embodiment, the constraint transformation unit 11 inputs a list of all equality constraints included in the constrained binary optimization problem in addition to the inequality constraint to be transformed to the inequality constraint transformation unit 121.

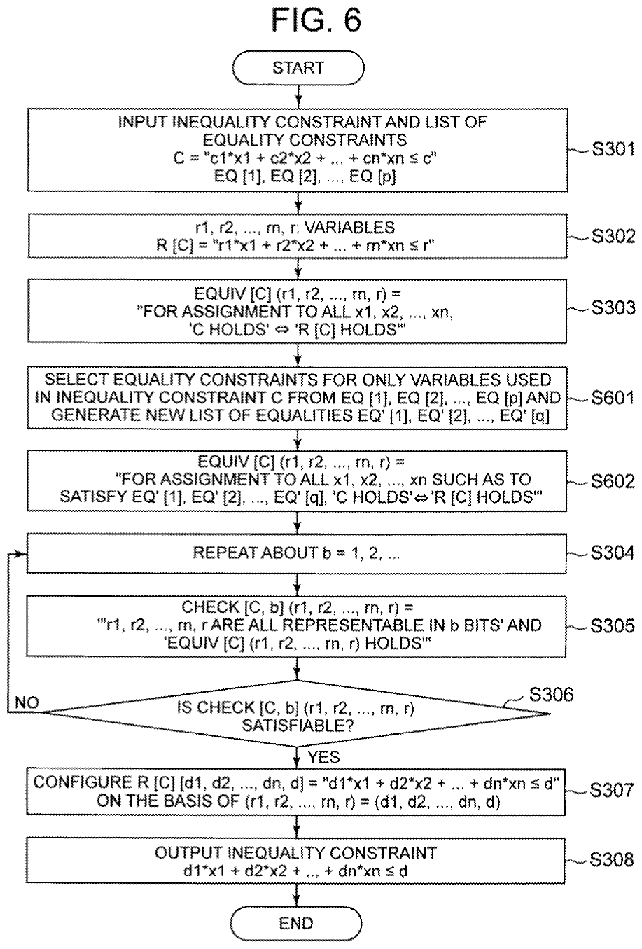

Next, the operation of the inequality constraint transformation unit 121 in the information processing device 30 of the third example embodiment will be described. FIG. 6 is a flowchart showing the operation of the inequality constraint transformation unit 121.

The constraint transformation unit 121 receives the inequality constraint C=“c1*x1+c2*x2+ . . . +cn*xn≤c” to be transformed as input from the constraint transformation unit 11, and the list of all equality constraints EQ [1], EQ [2], . . . , EQ [p] included in the constrained binary optimization problem (Step S301).

The inequality constraint transformation unit 121 is generated by performing the same step S302 and step S303 as in FIG. 3 for the inequality constraint C to generate the constraint equation EQUIV (r1, . . . , rn, r).

The inequality constraint transformation unit 121 selects equality constraints for only the variables used in inequality constraint C from the list of equality constraints EQ [1], EQ [2], . . . , EQ [p] and generates a new list of equality constraints EQ′ [1], EQ′ [2], . . . , EQ′ [q] (Step S601).

The process of step S601 will be explained in detail. Assume that “x1+2*x2−5*x4+x6≤3” as inequality constraint and EQ [1]=“x1+x2=x3”, EQ [2]=“x2+x4=1”, EQ [3]=“x1+x3=x5” and EQ [4]=“x2+x4=x6” as equality constraints are given as input.

The inequality constraint C concerns the variables x1, x2, x4, and x6.

The equality constraint EQ [1] concerns the variables x1, x2, x3. The equality constraint EQ [2] concerns the variables x2, x4. The equality constraint EQ [3] concerns the variables x1, x3, x5. The equality constraint EQ [4] concerns the variables x2, x4, x6.

Therefore, in step S601, the inequality constraint transformation unit 121 outputs a list of equality constraints for equality constraints EQ [2] and EQ [4].

The above is the description of the process in step S601 when a specific input is made.

Next, the inequality constraint transformation unit 121 relates the list of equality constraints EQ′ [1], EQ′ [2], . . . , EQ′ [q] obtained the step S601 to the constraint EQUIV (r1, m, r)=“For an assignment to all x1, x2, . . . , xn ‘the inequality constraint C holds’ ⇔ ‘the constraint equation R [C] holds’”, and updates the constraint EQUIV (r1, . . . , m, r) as follows (Step S602).

EQUIV (r1, . . . , rn, r)=“For an assignment to all x1, x2, . . . , xn that satisfy EQ′ [1], EQ′ [2], . . . , EQ′ [q], ‘the inequality constraint C holds’ ⇔ ‘the constraint equation R [C] holds’”

Thereafter, by the same operation as in step S304 and thereafter in FIG. 3, the sufficiency determination unit 13 obtains an assignment of values to r1, r2, . . . , m, r that satisfy EQUIV (r1, m, r). The inequality constraint transformation unit 121 returns the inequality constraint R [C] [d1, . . . , dn, d]=d1*x1+ . . . +dn*xn≤d as output.

The above is a description of the operation of the inequality constraint transformation unit 121.

Next, it will be supplementarily explained that the original inequality constraints C included in the constrained binary optimization problem OPT are replaced by the inequality constraints returned by the inequality constraint transformation unit 121 according to the procedure described above.

In step S602, it is assumed that the constraint EQUIV (r1, r2, . . . , m, r) after being updated by relating the equality constraints EQ′ [1], EQ′ [q] is considered, and the inequality constraint transformation unit 121 configures the inequality constraint R [C] [d1, . . . , dn, d] on the basis of the assignment of values, i.e., (r1, r2, . . . , m, r)=(d1, d2, . . . , dn, d) that satisfy this constraint.

From the definition of the constraint EQUIV (r1, r2, . . . , rn, r), the inequality constraint R [C] [d1, . . . , dn, d] is equivalent to the original inequality constraint C “only if x1, x2, . . . , xn satisfy EQ′ [1], EQ′ [q]”. Since the constrained binary optimization problem OPT includes the equality constraints EQ′ [1], EQ′ [q] as constraints, even if the inequality constraint C in OPT is transformed to R [C] [d1, . . . , dn, d], the satisfaction domain of “all constraints included in OPT” will not change.

From the above, even if the original inequality constraint in the constrained binary optimization problem is transformed to the inequality constraint returned when the original inequality constraint is input to the inequality constraint transformation unit 121, the optimal solution of the original constrained binary optimization problem will not change.

As described above, the information processing device 30 of the third example embodiment has the same effect as the information processing device 10 of the first example embodiment, but by transforming an inequality constraint by the inequality constraint transformation unit 121 instead of the inequality constraint transformation unit 12, it is possible to obtain the two effects described below.

The first is the effect that the third example embodiment of the information processing device 30 may be able to transform to an inequality constraint with fewer coefficient sizes and fewer variables.

For example, the constraint equation 5*x1+8*x2+5*x3≤9 can be transformed to x2≤0 with a coefficient size of 2 if the assumption is that the equality constraint “x1+x3=1” holds, whereas the equivalent inequality constraint of the minimum coefficient size to the constraint equation is x1+2*x2+x3≤2 with a coefficient size of 3.

The second is that the information processing device 30 of the third example embodiment may be able to transform an inequality constraint faster. The effect is mainly due to the fact that the number of repetition of the repeat steps S304 to S306 in FIG. 6 is reduced from the number of repetition regarding the first effect described above.

### Example Embodiment 4

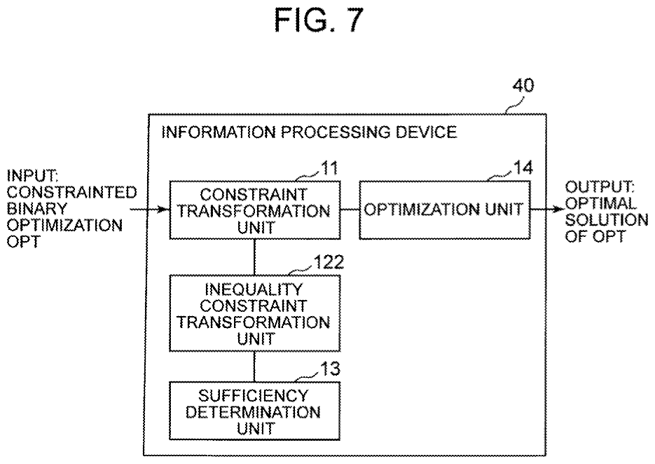

Hereinafter, the fourth example embodiment of the present invention will be described with reference to the drawings. FIG. 7 is a block diagram showing an example of the information processing device 40 of the fourth example embodiment. The information processing device 40 of the fourth example embodiment includes four processing blocks described in FIG. 7. That is, the information processing device 40 includes a constraint transformation unit 11, an inequality constraint transformation unit 122, a sufficiency determination unit 13, and an optimization unit 14.

The information processing device 40 shares most of the same features as the information processing device 10. However, the information processing device 40 is connected to an inequality constraint transformation unit 122 with different operation instead of the inequality constraint transformation unit 12.

The operation of the information processing device 40 of the fourth example embodiment will be described. The configuration of the information processing device 40 of the fourth example embodiment is the same as that of the information processing device 10, except for the two differences described below.

The first difference is that the constrained binary optimization problem, that the information processing device 40 of the fourth example embodiment receives as input, includes the coefficients and constant terms of the inequality constraints which are all integers and includes one or more “ONE-HOT constraints” on the variables. “ONE-HOT constraint” is a constraint expressing that “only one of the variables x1, x2, . . . , xn is 1 and the others are 0”. For a constrained binary optimization problem, it is expressed as the following equation constraint (Note that no variable can be included in two or more ONE-HOT constraint at the same time).

x1+x2+ . . . +xn=1

The second difference is that the information processing device 40 of the fourth example embodiment transforms an inequality constraint using the inequality constraint transformation unit 122 instead of the inequality constraint transformation unit 12. In this case, the constraint transformation unit 11 inputs to the inequality constraint transformation unit 122 not only the inequality constraint to be transformed but also a list consisting of all ONE-HOT constraints included in the constrained binary optimization problem.

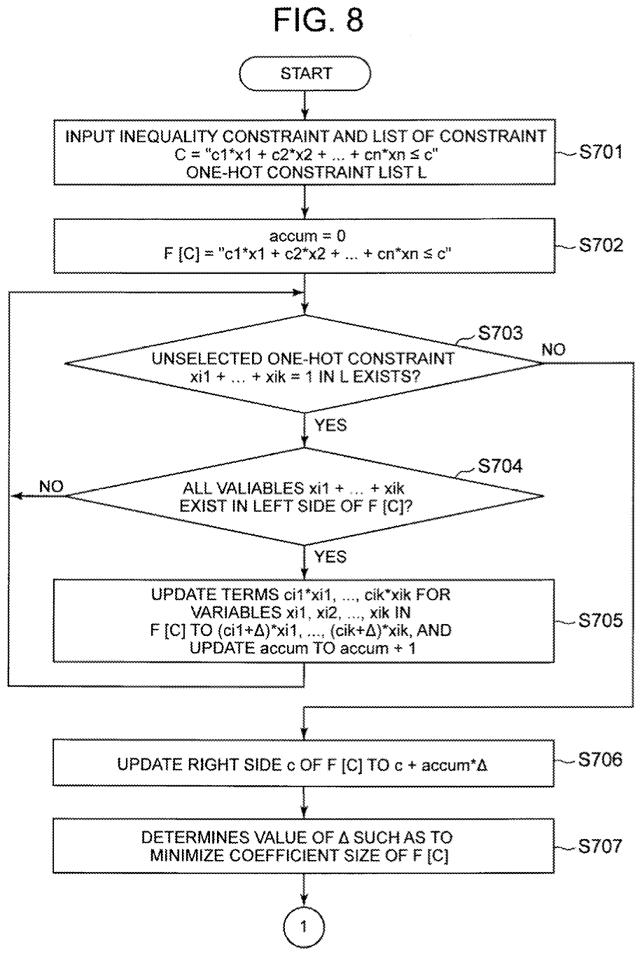

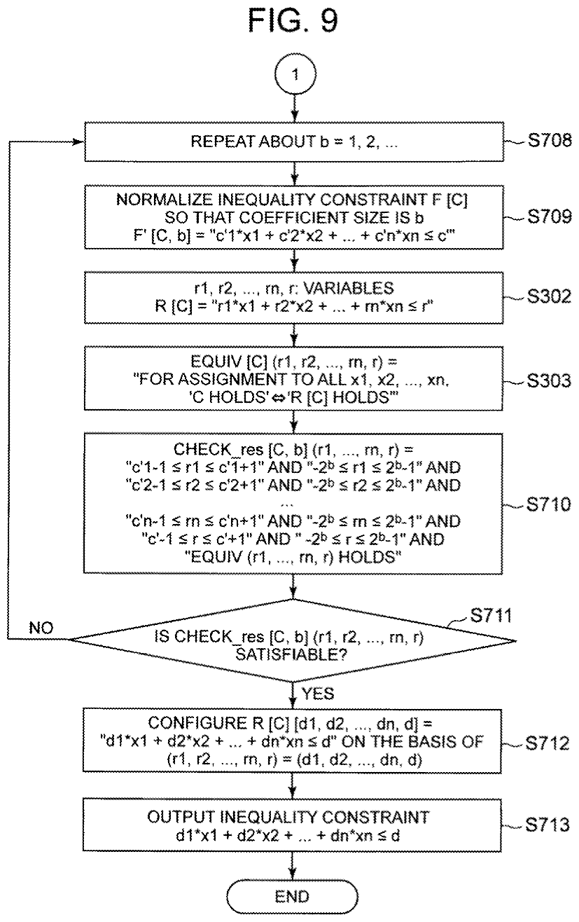

Next, the operation of the inequality constraint transformation unit 122 in the information processing device 40 of the fourth example embodiment will be described. FIG. 8 is a flowchart showing the operation of the inequality constraint transformation unit 122.

The inequality constraint transformation unit 122 receives the inequality constraint C “c1*x1+c2*x2+ . . . +cn*xn≤c” as input from the constraint transformation unit 11 and the list of ONE-HOT constraints as described above (Step S701).

The inequality constraint transformation unit 122 sets 0 in the variable accum and a copy of the inequality constraint C in the variable F [C] as initial values, respectively (Step S702).

In step S703, the inequality constraint transformation unit 122 selects one from the list of ONE-HOT constraints received as input and performs the repeat process. In the following, the selected ONE-HOT constraint is set to xi1+xi2+xik=1.

The inequality constraint transformation unit 122 checks whether all variables xi1, xi2, xik are included in the left side of the inequality constraint F [C]. When all the variables xi1, xi2, . . . , xik are included in the left side of the inequality constraint F [C], the process proceeds to step S705. When all the variables xi1, xi2, . . . , xik are not included in the left side of the inequality constraint F [C], the process returns to step S703 (Step S704).

The inequality constraint transformation unit 122 transforms the terms for the variables xi1, xi2, . . . , xik in the inequality constraint F [C] to ci1*xi1, ci2*xi2, . . . , cik*xik. Next, the inequality constraint transformation unit 122 adds a variable A to the coefficients of these terms in the inequality constraint F [C] to update to (ci1+Δ)*xi1, (ci2+Δ)*xi2, . . . , (cik+Δ)*xik. Then, the inequality constraint transformation unit 122 adds 1 to the variable accum (Step S705).

The “update coefficients” operation above corresponds to modifying the left side of the inequality constraint F [C] so that the value of the left side of F [C] for the assignment of values to all x1, . . . , xn such that the ONE-HOT constraint xi1+xi2+xik=1 holds is increased by just Δ.

When there are no more unselected ONE-HOT constraints in step S703, the process proceeds to step S706.

In step S706, the inequality constraint transformation unit 122 adds accum*Δ to the right side c of the inequality constraint F [C] and updates the right side to c+accum*Δ (since c and accum are constants, the right side includes only Δ as a variable).

The meaning of this adjustment of the right side is explained below. The inequality constraint transformation unit 122 updates some of the terms in the left side in step S705. When this update operation is done once, the value in the left side becomes larger by “just Δ” for values assigned to all the x1, . . . , xn that satisfy the ONE-HOT constraint.

Then, when the process reaches step S706, the inequality constraint F [C] will take a value larger than the left side of the original inequality constraint C by “(number of times step S705 is executed)×Δ”=“accum*Δ”.

If accum*Δ is added to the right side, then for values assigned to all the x1, . . . , xn values that satisfy the ONE-HOT constraint, the values on the left and right sides of the inequality constraint F [C] are both exactly accum*Δ larger than the values on the left and right sides of the inequality constraint C. This indicates that for the assignment of values to all x1, . . . , xn value that satisfy the ONE-HOT constraint, the satisfaction of the original inequality constraint C and the satisfaction of the inequality constraint F [C] are equivalent.

The above is the meaning of step S706. After the end this step, the inequality constraint C under the ONE-HOT constraint and the inequality constraint F [C] are equivalent regardless of the value of A.

Next, the inequality constraint transformation unit 122 calculates one value of A that minimizes the coefficient size of the inequality constraint F [C], and assigns the value to each A in the inequality constraint F [C] (Step S707).

For example, step S707 is implemented by a method where the maximum value of c1, c2, . . . , cn, −c1, −c2, . . . , cn is regarded as c_max, and the coefficient size is actually examined while varying A is the respective value from −c_max to c_max, but the implemented method is not limited to this.

Next, the inequality constraint transformation unit 122 then repeatedly executes step S709 to step S711 while increasing the value of the variable b from b=1 to b=2, 3, . . . (Step S708).

In step S709, the inequality constraint transformation unit 122 configures an inequality constraint F′ [C, b], where the coefficients of the inequality constraint F [C] are “normalized” so that the coefficient size of F [C] is b.

The normalization of the above inequality constraint F [C] can be implemented by repeating the operation “divide the coefficient by 2 and truncate the remainder” until the coefficient size is less than or equal to b, or by multiplying the entire inequality constraint by a constant so that the maximum value of the coefficient is 2^{b}−1 (or the minimum value is −2b) and rounding to an integer in an appropriate method, but not limited to these.

For the sake of explanation, let F′ [C, b]=“c′1*x1+c′2*x2+ . . . +c′n*xn≤c′”.

Next, using the same procedure that the inequality constraint transformation unit 12 performed in step S302 and step S303, the inequality constraint transformation unit 122 newly introduces n+1 variables r1, r2, . . . , rn, r, and generates a constraint equation R [C] and constraint EQUIV (r1, . . . , rn, r).

In step S710, the inequality constraint transformation unit 122 configures the following constraint CHECK_res [C, b] (r1, . . . , rn, r) on the basis of the constraint EQUIV (r1, . . . , m, r).

CHECK_res [C, b] (r1, . . . , m, r)=“c′1−1≤r1≤c′1+1” and “−2^{b}≤r1≤2^{b}−1” and “c′2−1≤r2≤c′2+1” and . . . “−2^{b}≤r2≤2b−1” and . . . “c′n−1≤m≤c′n+1” and “−2^{b}≤rn≤2^{b}−1” and “c′−1≤r≤c′+1” and “−2^{b}≤r≤2^{b}−1” and “EQUIV (r1, . . . , rn, r) holds”

Here, the meaning of the constraint CHECK_res [C, b] (r1, . . . , rn, r) is explained.

The constraint CHECK_res [C, b] (r1, . . . , rn, r) is almost identical in meaning to the constraint CHECK [C, b] (r1, . . . , m, r) that the inequality constraint transformation unit 12 has configured in step S305, but with the addition of “c′i-1, c′i, c′i+1” as a condition to be satisfied by the variable ri. In other words, the constraint CHECK_res [C,b] (r1, . . . , m, r) imposes a truly stronger condition on the variables r1, . . . , m, r than the constraint CHECK [C,b] (r1, . . . , m, r).

Therefore, if an assignment of values (r1, r2, . . . , rn, r)=(d1, d2, . . . , dn, d) for the variables r1, . . . , m, r such that satisfies the constraint CHECK_res [C, b] (r1, . . . , rn, r) exists, then an inequality constraint R [C] [d1, . . . , dn, d] that is equivalent to the inequality constraint C and whose coefficient size is less than or equal to b is obtained.

The above is an explanation of the meaning of the constraint CHECK_res [C, b] (r1, . . . , m, r).

The inequality constraint transformation unit 122 inputs the constraint CHECK_res [C, b] (r1, . . . , m, r) to the sufficiency determination unit 13. When the result of the sufficiency determination unit 13 is “satisfiable” (Step S711), the process proceeds to step S712. When the result of the sufficiency determination unit 13 is “unsatisfiable” (Step S711), the process returns to step S708.

In step S712, the inequality constraint transformation unit 122 configures the inequality constraint R [C] [d1, . . . , dn, d] on the basis of the value assignment (r1, r2, . . . , m, r)=(d1, d2, dn, d) output from the sufficiency determination unit 13, and outputs the result.

The above is an explanation of the operation of transforming an inequality constraint to another inequality constraint with smaller coefficient sizes of the inequality constraint transformation unit 122 in the fourth example embodiment.

As explained above, the information processing device 40 of the fourth example embodiment performs optimization by the optimization unit 14 after transforming the input constrained binary optimization problem into an equivalent constrained binary optimization problem with a smaller coefficient size, similar to the information processing device 10 of the first example embodiment. As a result, the information processing device 40 of the fourth example embodiment can obtain an optimal solution to an optimization problem for which an optimal solution cannot be obtained directly due to the original hardware constraints.

On the other hand, the inequality constraint transformation unit 122 does not necessarily output the inequality constraint with the smallest coefficient size for the input inequality constraint. However, the constraint to be solved to obtain the coefficients is very strong constraint compared to the constraint by the inequality constraint transformation unit 12. Therefore, the checking of satisfiability by the sufficiency determination unit 13 is completed much faster than in the case of the information processing device 10.

From the above, the information processing device 40 of the fourth example embodiment can output the optimal solution in a shorter time than the information processing device 10.

The optimization unit 14, which includes the problem transformation unit 141 and the optimal solution calculation unit 142 shown in FIG. 4, can be used instead of the optimization unit 14 in the third example embodiment shown in FIG. 5 and the fourth example embodiment shown in FIG. 7.

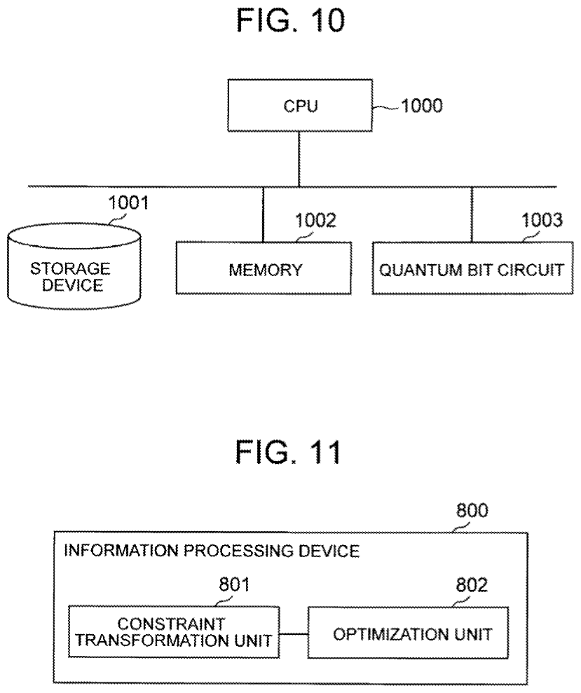

FIG. 10 illustrates a hardware configuration for realizing the information processing device 10. The information processing device 10 has a CPU 1000, a storage device 1001, a memory 1002, and a quantum bit circuit 1003.

Each component in the information processing device 10 shown in FIG. 1, except for the optimization unit 14, can be configured with one hardware or one software. Each component can also be configured with multiple pieces of hardware or multiple pieces of software. It is also possible to configure some parts of each component with hardware and other parts with software.

When each component in the information processing device 10 is realized by a computer having a processor such as a CPU (Central Processing Unit) and a memory, for example, the computer can be realized by a computer having the CPU shown in FIG. 10. In the computer, the CPU 1000 realizes each function in the information processing device 10 shown in FIG. 1 by executing processing (information processing) according to a program stored in the storage device 1001. In other words, the computer realizes all of the functions of the constraint transformation unit 11, the inequality constraint transformation unit 12 and the sufficiency determination unit 13, and part of the functions of the optimization unit 14 in the information processing device 10 shown in FIG. 1. The CPU 1000 may be a semiconductor device placed at room temperature or a superconducting circuit cooled to an extremely low temperature of several mK to several K.

The storage device 1001 is, for example, a non-transitory computer readable medium. A non-transitory computer readable medium can be any of various types of tangible storage media. Examples of non-transitory computer readable media include a magnetic recording medium (e.g., hard disk), a magneto-optical recording medium (e.g., magneto-optical disk), CD-ROM

(Compact Disc-Read Only Memory), a CD-R (Compact Disc-Recordable), a CD-R/W (Compact Disc-ReWritable), a semiconductor memory (e.g., mask ROM, PROM (Programmable ROM), EPROM (Erasable PROM), flash ROM).

The program may also be stored on various types of transitory computer readable media. The transitory computer readable medium is supplied with the program, for example, through wired or wireless communication channels, i.e., through an electrical signal, optical signal, or an electromagnetic wave.

The memory 1002 is realized, for example, by RAM (Random Access Memory), and is storage means for temporarily storing data when the CPU 1000 executes processing. It can be assumed that a program held by the storage device 1001 or a temporary computer readable medium is transferred to the memory 1002, and that the CPU 1000 executes processing on the basis of the program in the memory 1002.

The quantum bit circuit 1003 controls the quantum fluctuation of the quantum bit circuit, the strength of the coupling between quantum bits, and the magnetic field during quantum annealing. For example, the information processing device 10 (especially the optimization unit 14) in each of the above example embodiments can be realized by an annealing machine including the quantum bit circuit 1003. The annealing machine to realize the optimization unit 14 can also be constructed by using CMOS (Complementary Metal Oxide Semiconductor) or FPGA (Field Programmable Gate Array) in addition to using the quantum bit circuit 1003.

FIG. 11 shows a block diagram of the main part of the information processing device. The information processing device 800 is an information processing device that outputs an optimal solution to a binary optimization problem when the binary optimization problem including a linear inequality constraint represented by at least a linear inequality is input, comprises a constraint transformation unit 801 (realized by the constraint transformation unit 11 in the example embodiment) which transforms the constraint to a constraint represented by the linear inequality with a coefficient size smaller than the coefficient size of the linear inequality, and an optimization unit 802 (realized by the optimization unit 14 in the example embodiment) which calculates the optimal solution of the binary optimization problem on the basis of the constraint including the linear inequality transformed by the constraint transformation unit 801.

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

### REFERENCE SIGNS LIST

10, 20, 30, 40 information processing device
11 constraint transformation unit
12, 121, 122 inequality constraint transformation unit
13 sufficiency determination unit
14 optimization unit
141 problem transformation unit
142 optimal solution calculation unit
800 information processing device
801 constraint transformation unit
802 optimization unit
1000 CPU
1001 storage device
1002 memory
1003 quantum bit circuit

1. An information processing device that outputs an optimal solution to a binary optimization problem when the binary optimization problem including a linear inequality constraint represented by at least a linear inequality is input comprising:
a constraint transformation unit which transforms the constraint to a constraint represented by the linear inequality with a coefficient size smaller than the coefficient size of the linear inequality, and
an optimization unit which calculates the optimal solution of the binary optimization problem on the basis of the constraint including the linear inequality transformed by the constraint transformation unit.

2. The information processing device according to claim 1, further comprising
an inequality constraint transformation unit which transforms the coefficient size of the linear inequality so that an assignment of values to variables that satisfy the input linear inequality constraint does not change.

3. The information processing device according to claim 2, wherein
the binary optimization problem includes equality constraints, and
the inequality constraint transformation unit transforms the linear inequality constraint so that all the input equality constraints are satisfied.

4. The information processing device according to claim 2, wherein
the binary optimization problem includes an equality constraint that requires only one of the multiple Boolean variables to be assigned 1, and
the inequality constraint transformation unit transforms the inequality constraint by modifying the equation using the equation constraint.

5. The information processing device according to claim 3, wherein
the binary optimization problem includes an equality constraint that requires only one of the multiple Boolean variables to be assigned 1, and
the inequality constraint transformation unit transforms the inequality constraint by modifying the equation using the equation constraint.

6. The information processing device according to claim 1 wherein
the optimization unit includes a problem transformation unit which transforms the binary optimization problem into a quadratic unconstrained binary optimization problem, and
an optimal solution calculation unit which calculates the optimal solution for the quadratic unconstrained binary optimization problem transformed by the problem transformation unit.

7. The information processing device according to claim 2 wherein
the optimization unit includes a problem transformation unit which transforms the binary optimization problem into a quadratic unconstrained binary optimization problem, and
an optimal solution calculation unit which calculates the optimal solution for the quadratic unconstrained binary optimization problem transformed by the problem transformation unit.

8. The information processing device according to claim 3 wherein
the optimization unit includes a problem transformation unit which transforms the binary optimization problem into a quadratic unconstrained binary optimization problem, and
an optimal solution calculation unit which calculates the optimal solution for the quadratic unconstrained binary optimization problem transformed by the problem transformation unit.

9. The information processing device according to claim 4 wherein
the optimization unit includes a problem transformation unit which transforms the binary optimization problem into a quadratic unconstrained binary optimization problem, and
an optimal solution calculation unit which calculates the optimal solution for the quadratic unconstrained binary optimization problem transformed by the problem transformation unit.

10. An information processing method that outputs the optimal solution to a binary optimization problem when the binary optimization problem including a linear inequality constraint represented by at a least linear inequality is input comprising:
transforming the constraint to a constraint represented by the linear inequality with a coefficient size smaller than the coefficient size of the linear inequality, and
calculating the optimal solution of the binary optimization problem on the basis of the constraint including the transformed linear inequality.

11. The information processing method according to claim 10, further comprising
transforming the coefficient size of the linear inequality so that an assignment of values to variables that satisfy the input linear inequality constraint does not change.

12. The information processing method according to claim 11, wherein
the binary optimization problem includes equality constraints, and
transforming the linear inequality constraints so that all the input equality constraints are satisfied.

13. A non-transitory computer-readable storage medium recording an information processing program for outputting an optimal solution to a binary optimization problem when the binary optimization problem including a linear inequality constraint represented by at least a linear inequality is input which, when executed by a computer, performs:
transforming the constraint to a constraint represented by the linear inequality with a coefficient size smaller than the coefficient size of the linear inequality, and
calculating the optimal solution of the binary optimization problem on the basis of the constraint including the transformed linear inequality.

14. The non-transitory computer-readable storage medium according to claim 13, wherein
the information processing program further performs
transforming the coefficient size of the linear inequality so that an assignment of values to variables that satisfy the input linear inequality constraint does not change.
